(19) United States
(12) Patent Application Publication
(10) Pub. No.: US 2005/0280627 A1
(43) Pub. Date: Dec. 22, 2005

(54) Image writing apparatus, connector and display record medium

(75) Inventors: Minoru Koshimizu, Tokyo (JP); Naoki Hayashi, Tokyo (JP); Yoshitsugu Hirose, Tokyo (JP); Hiroyuki Hotta, Tokyo (JP); Tsutomu Ishii, Tokyo (JP); Yasunori Saito, Tokyo (JP); Ikutaroh Nagatsuka, Tokyo (JP); Eriko Tamaru, Kanagawa (JP); Kimitake Hasuike, Kanagawa (JP); Tsunemasa Mita, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/012,346

(22) Filed: Dec. 16, 2004

(30) Foreign Application Priority Data
Jun. 10, 2004 (JP) P2004-173088

(51) Int. Cl. H04N 7/26

(52) U.S. Cl. 345/156; 345/173

(57) ABSTRACT

To provide an image writing apparatus with good operability capable of surely rewriting an image and management information, a connector and a display record medium. When electronic paper (display record medium) capable of visibly displaying an image without a power source is attached to a connector and the electronic paper is held over screen parts and an operation button provided in the connector is depressed, a pulse voltage is supplied to an image display record area of the electronic paper and also an image is written by irradiation with image light and management information inside an IC chip of the electronic paper is rewritten.

### BACKGROUND OF THE INVENTION

1. Field of the Invention

The present invention relates to an image writing apparatus for writing an image into a display record medium capable of visibly displaying an image without a power source, a connector and a display record medium, and particularly to an image writing apparatus with good operability capable of surely rewriting management information in the case of writing an image, a connector and a display record medium.

2. Description of the Related Art

In recent years, a display record medium referred to as electronic paper or digital paper having both a merit of an electronic display capable of rewriting an image and a merit of paper capable of visibly displaying an image without a power source has received attention.

There is means shown in JP-A-2003-75865 as an image writing apparatus of such a display record medium.

The image writing apparatus described in JP-A-2003-75865 includes a projector for projecting image light on a light control screen capable of switching between a light transmission state and a light scattering state, a light writing type display record medium made by laminating a liquid crystal layer and a photoconductive layer and arranging the layers between a pair of transparent electrodes, and a clip type connector for voltage application, the connector for being attached to this display record medium and applying a voltage between the pair of transparent electrodes.

In such a configuration, when image light is projected on the light control screen of a light scattering state from the projector, the image light is scattered on the light control screen, so that an image projected can be observed in a wide range. When the light writing type display record medium is clipped by the clip type connector for voltage application and this is held on the projected image and a voltage application start button provided in the connector for voltage application is depressed, the light control screen is switched to a light transmission state and a voltage is applied to the display record medium and image light passing through the light control screen is written into the display record medium.

According to this configuration, an image on the screen can easily be copied to the display record medium. However, contents can be written into the display record medium without limitation, so that the contents may be provided for a user without having the right to obtain the contents.

Thus, a conventional image writing apparatus constructed so as to record management information such as a user ID or a medium ID into a display record medium is proposed (for example, refer to JP-A-2004-102432).

The image writing apparatus described in JP-A-2004-102432 is constructed so that in a manner similar to the image writing apparatus described in JP-A-2003-75865, there are provided a light control screen, a projector, a light writing type display record medium and a connector for voltage application and further an RFID tag is provided in the light writing type display record medium and a management information writing part is provided adjacent to the projector and an address, a file name, etc. of an image written into a display part of the display record medium are recorded into the RFID tag by the management information writing part. According to this configuration, even when the image written into the display part is erased later, the same image can be obtained based on the address etc. recorded into the RFID tag.

### SUMMARY OF THE INVENTION

However, according to an image writing apparatus of JP-A-2004-102432, writing instructions of management information into an RFID tag are required in addition to an operation of a voltage application start button, so that the operation becomes complicated and also writing instructions of management information may be omitted. Further, the management information is read and written into the RFID tag from a remote place, so that power is required in a signal of sending and receiving and also noise may break into the signal. Also, in order to use the management information written into the RFID tag, dedicated reader and writer are required, so that usability reduces.

Therefore, an object of the invention is to provide an image writing apparatus with good operability capable of surely rewriting management information in a case of writing image information, and a connector.

Also, another object of the invention is to provide a display record medium for improving usability of management information written into a display record medium.

In order to achieve the objects, according to the invention, there is provided an image writing apparatus including a connector capable of being attached to and detached from a display record medium capable of rewriting information and visibly displaying image information without a power source, a button which is provided on the connector and outputs a writing command signal of the information by an operation, and a writing part which applies a writing signal of the image information and management information about the image information from the connector to the display record medium by control of a control part based on the writing command signal.

According to the configuration described above, when a connector is attached to a display record medium and a button is depressed, a writing command signal is outputted from the button and image information and management information about the image information are written into the display record medium using the writing command signal as a trigger. Here, “management information about image information” is a wide concept including a user ID, a medium ID, etc. and is mainly written by digital information, but may be written by analog information. The image information and the management information may be written into the same area of the display record medium or may be written into different areas.

In order to achieve the objects, according to the invention, there is provided a connector capable of being attached to and detached from a display record medium having rewritable image display area and management information record area, including: a button which output a writing command signal to the image display area and the management information record area by an operation; an output terminal which applies a writing signal of image information to the image display area by making connection to an input terminal of the display record medium when the connector is attached to the display record medium; and a reading and writing part which reads and writes management information about the image information with respect to the management information record area.

According to the configuration described above, when a connector is attached to a display record medium and a button is depressed, a writing command signal is outputted from the button and using the writing command signal as a trigger, image information is written into an image display area of the display record medium and management information is written into a management information record area. A writing signal of the image information may be sent by bringing an input terminal of the medium side into contact with an output terminal of the connector side, or may be sent by noncontact by making connection optically, magnetically or thermally.

In order to achieve the objects, the invention provides a display record medium having rewritable image display area and management information record area, including: a memory card detachably provided on the display record medium, wherein the management information record area is formed in the memory card.

According to an image writing apparatus and a connector of the invention, image information and management information about the image information can be rewritten by an operation of a button, so that operability is good and the image information and the management information can be rewritten surely.

According to a display record medium of the invention, usability of management information improves by using a memory card with great versatility.

### BRIEF DESCRIPTION OF THE DRAWING

These and other objects and advantages of this invention will become more fully apparent from the following detailed description taken with the accompanying drawings in which:

FIG. 1 is a perspective view showing an electronic paper system according to a first embodiment of the invention;

FIG. 2 is a plan view of light writing type electronic paper according to the first embodiment of the invention;

FIG. 3 is a sectional view taken on line A-A of FIG. 2;

FIG. 4 shows a connector according to the first embodiment of the invention and FIG. 4A is a plan view and FIG. 4B is a sectional view taken on line B-B of FIG. 4A;

FIG. 5 is a block diagram showing a control system of the electronic paper system according to the first embodiment of the invention;

FIG. 6 is a plan view showing a display example of a screen part according to the first embodiment of the invention;

FIG. 7 is a plan view showing a display example of a screen part according to the first embodiment of the invention;

FIG. 8 is a plan view showing a display example of a screen part according to the first embodiment of the invention;

FIG. 9 is a plan view showing a display example of a screen part according to the first embodiment of the invention;

FIG. 10 is a flowchart showing an action of the electronic paper system according to the first embodiment of the invention;

FIG. 11 is a sectional view showing electronic paper according to a second embodiment of the invention;

FIG. 12 is a perspective view showing a control system of an electronic paper system according to a third embodiment of the invention;

FIG. 13 is a block diagram showing the control system of the electronic paper system according to the third embodiment of the invention;

FIG. 14 is a flowchart showing an action of the electronic paper system according to the third embodiment of the invention; and

FIGS. 15A to 15D are plan views showing use forms of the electronic paper system according to the third embodiment of the invention.

### DETAILED DESCRIPTION OF THE PREFERRED EMBODIMENTS

### First Embodiment

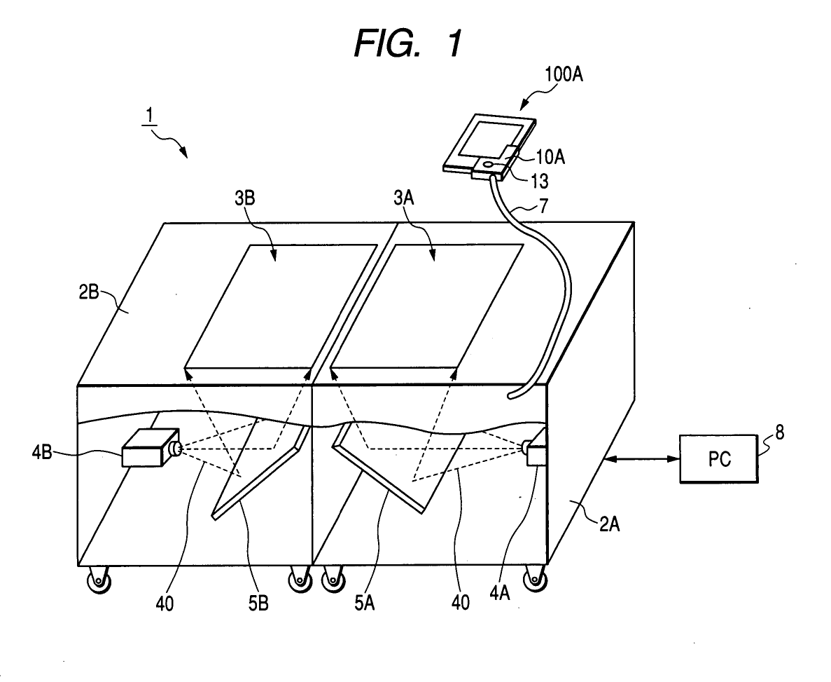

FIG. 1 is a perspective view showing an electronic paper system according to a first embodiment of the invention. This electronic paper system is configured to have light writing type electronic paper 100A acting as a display record medium and an image writing apparatus 1 for writing image information and management information about the image information into this electronic paper 100A.

Here, attribute information about a user, attribute information about the electronic paper, attribute information about an image, etc. are included in “management information”. The following information is included in these attribute information, but the management information is not limited to these classifications.

(1) An ID, a name, sex, age, an address of the user using the system, information about the presence or absence of the right to obtain contents selected, information about accounting in the case of acquiring contents selected, etc. are included in the attribute information about the user.

(2) An electronic paper ID, information about a use environment such as temperature, humidity of the electronic paper, information about a use position such as latitude, longitude, altitude of the electronic paper, information about a use history such as the number of rewritings of the electronic paper, etc. are included in the attribute information about the electronic paper.

(3) Information about a source of a written image, information about a link to a source of a written image, information about a file path in which a selected document is stored, a document ID, a book ID such as ISBN (International Standard Book Number), time for which information is browsed, place information, etc. are included in the attribute information about the image.

(Whole Configuration of Image Writing Apparatus)

The image writing apparatus 1 has two substantially box-shaped first and second cabinets 2A, 2B, first and second screen parts 3A, 3B respectively provided on upper surfaces of the cabinets 2A, 2B, first and second projectors 4A, 4B which are respectively provided inside the first and second cabinets 2A, 2B and project image light 40 on the screen parts 3A, 3B through mirrors 5A, 5B, a connector 10A which is connected to an under-mentioned controller unit provided inside the first cabinet 2A through a cable 7 and includes an operation button 13 for outputting a depression signal (writing command signal) by an operation and applies a voltage to the electronic paper 100A, and a personal computer (PC) 8 for controlling the controller unit and the projectors 4A, 4B.

Incidentally, the number of screen parts 3 (3A, 3B) is not limited to the two described above, and may be one or may be three or more. Also, the controller unit may be provided every screen part 3. Also, the connector 10A may be provided every screen part 3. A copying operation of an image can be performed efficiently by providing the connector 10A every screen part 3.

(Configuration of Light Writing Type Electronic Paper)

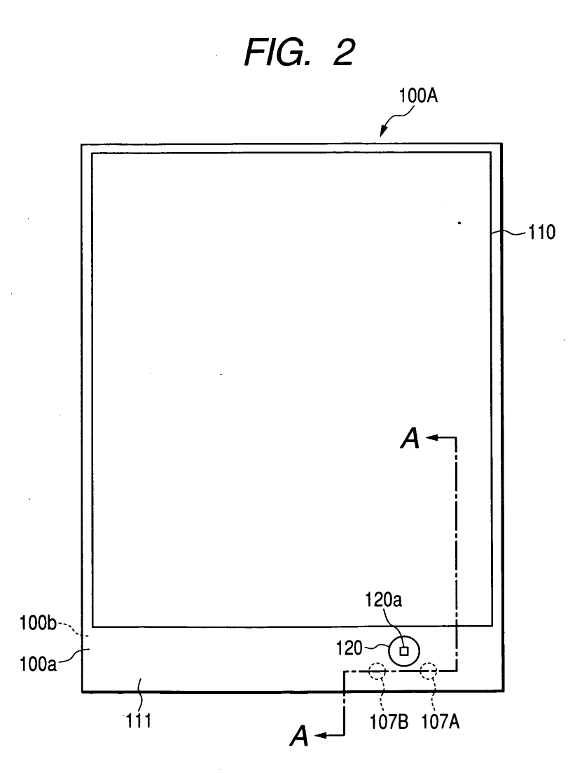

FIG. 2 is a plan view of the light writing type electronic paper 100A. This light writing type electronic paper 100A has a thin type rectangular shape, and an image display record area 110 is provided in the front 100a, and an RFID tag 120 made of an antenna (not shown) and an IC chip 120a acting as a management information record area are provided in a peripheral area 111 of the image display record area, and a pair of power receiving terminals 107A, 107B are provided in the back 100b.

Incidentally, an IC label or an IC card of a contact type may be used instead of the RFID tag 120. Also, management information may be read and written optically, magnetically or thermally according to a method for recording management information about the electronic paper into a record area.

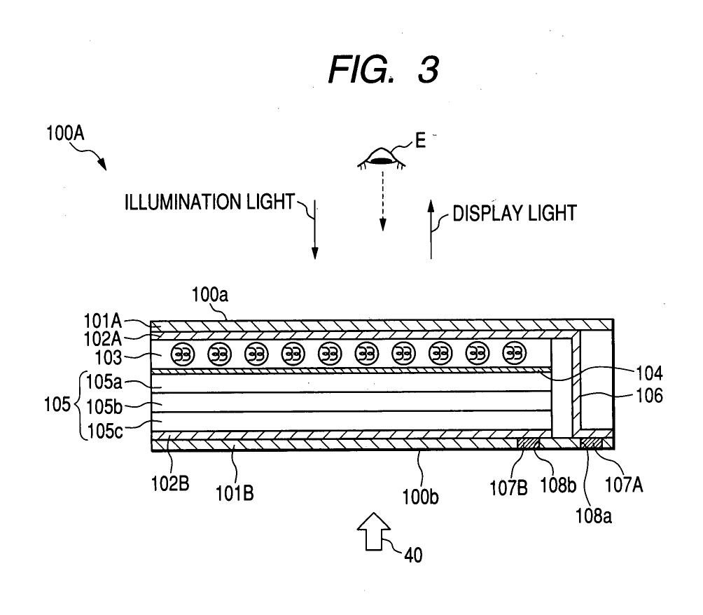

FIG. 3 is a sectional view taken on line A-A of FIG. 2. This light writing type electronic paper 100A is configured to include a pair of substrates 101A, 101B made of transparent PET (polyethylene terephthalate) films opposed and arranged, a pair of transparent electrodes 102A, 102B made of ITO (indium tin oxide) provided in the inside of these substrates, a liquid crystal layer 103 which is provided in the inside of the transparent electrode 102A of the side of the front 100a and is made of a liquid crystal having memory properties in which reflectance (transmittance) changes according to an applied voltage, for example, a cholesteric liquid crystal 103, a light absorption layer 104 provided in the inside of the liquid crystal layer 103, a photoconductive layer 105 which is provided between the light absorption layer 104 and the transparent electrode 102B of the side of the back 100b and whose resistance value reduces by irradiation with the image light 40, and an extending part 106 whose one end is connected to the transparent electrode 102A. The cholesteric liquid crystal can adopt a configuration enclosed in a microcapsule and dispersed in a resin binder. In the case of adopting this configuration, mechanical strength increases while limiting fluidity of a display layer, so that there is an advantage that a display image resists changing with respect to stress of bending or pressure from the outside.

A pair of openings 108a, 108b are provided in the substrate 101B of the side of the back 100b and the power receiving terminal 107A is provided on the extending part 106 of one opening 108a and the power receiving terminal 107B is provided on the transparent electrode 102B of the other opening 108b.

The photoconductive layer 105 includes two electric charge generation layers 105a, 105c and an electric charge transport layer 105b provided between these layers. By adopting a configuration in which the electric charge generation layers 105a, 105c are laminated to both ends of the electric charge transport layer 105b, an AC voltage can be applied to the liquid crystal layer 103 and deterioration of the liquid crystal layer 103 can be suppressed and lowering of a driving voltage and long life of the electronic paper 101A can be achieved.

(Action of Writing into Light Writing Type Electronic Paper)

Here, an action of writing an image into the electronic paper 100A will be described. When the back 100b is irradiated with image light 40 while applying a pulse voltage between a pair of the transparent electrodes 102A, 102B through a pair of the power receiving terminals 107A, 107B, the photoconductive layer 105 is irradiated with the image light 40 through the substrate 101B and the transparent electrode 102B. In the photoconductive layer 105, a resistance value decreases by irradiation with the image light 40 and thereby a partial pressure of the liquid crystal layer 103 determined by a ratio of impedance to the photoconductive layer 105 increases and a voltage exceeding a predetermined or more threshold value is applied and thereafter it is held in a state in which light reflectance in the liquid crystal layer 103 is large.

Therefore, when the electronic paper 100A is viewed from the front 100a, an area irradiated with the image light 40 receives illumination light and is reflected by the liquid crystal layer 103 and looks white as display light. Conversely, in an area which is not irradiated with the image light 40, a resistance value of the photoconductive layer 105 increases and a voltage which does not exceed a threshold value is applied to the liquid crystal layer 103 and thereafter the liquid crystal layer 103 is held in a state of transmitting light. Since light passing through this liquid crystal layer 103 is absorbed by the light absorption layer 104, the area which is not irradiated with the image light 40 looks black.

In this electronic paper 100A, a direction of irradiation with the image light 40 is opposite to a direction of viewing an image, so that a user can check the contents of the image at once when the front 100a of the electronic paper 100A is viewed from a direction of E without reversing the electronic paper 100A.

(Configuration of Connector)

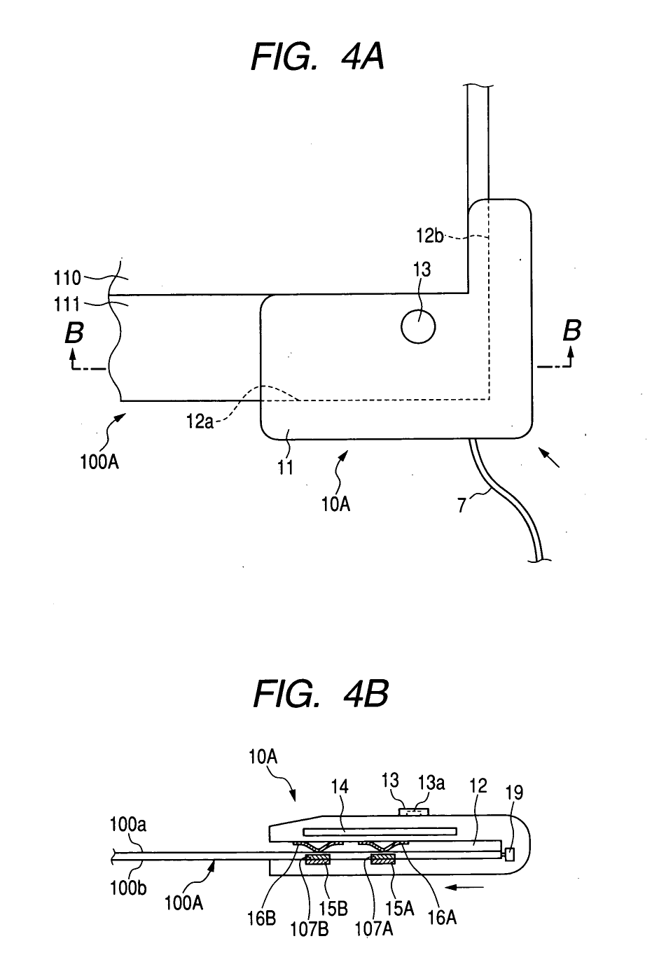

FIG. 4 shows the connector 10A and FIG. 4A is a plan view and FIG. 4B is a sectional view taken on line B-B of FIG. 4A. This connector 10A includes a substantially U-shaped case 11, an attachment opening 12 having abutment surfaces 12a, 12b of the electronic paper 100A, an operation button 13 which is provided protrudably from a surface of the case 11 and wherein an LED lamp 13a for emitting green light is buried in the surface side, a reader/writer 14 for reading and writing management information with respect to the IC chip 120a of the RFID tag 120, power feeding terminals 15A, 15B which are exposed to the attachment opening 12 and apply a pulse voltage to the power receiving terminals 107A, 107B of the electronic paper 100A attached to the attachment opening 12, and pressure springs 16A, 16B which are provided in positions opposed to the power feeding terminals 15A, 15B of the attachment opening 12 and press the electronic paper 100A attached to the attachment opening 12 to the sides of the power feeding terminals 15A, 15B, and in the case of attaching the connector 10A to the electronic paper 100A, the connector 10A is attached in a direction shown by an arrow of FIG. 4. At this time, when the electronic paper 100A is inserted to a predetermined abutment place of the inside of the connector 10A, it is configured so as to turn on the LED lamp 13a inside the operation button 13 described above when a lever of a limit switch 19 provided in an abutment position presses the end of the electronic paper 100A to shift to an ON state of the switch. By adopting this configuration, it is constructed so as to be able to check at a glance that a position between electrode terminals of the connector 10A and the electronic paper 100A is proper before a voltage is applied to the electronic paper 100A.

(Control System of Electronic Paper System)

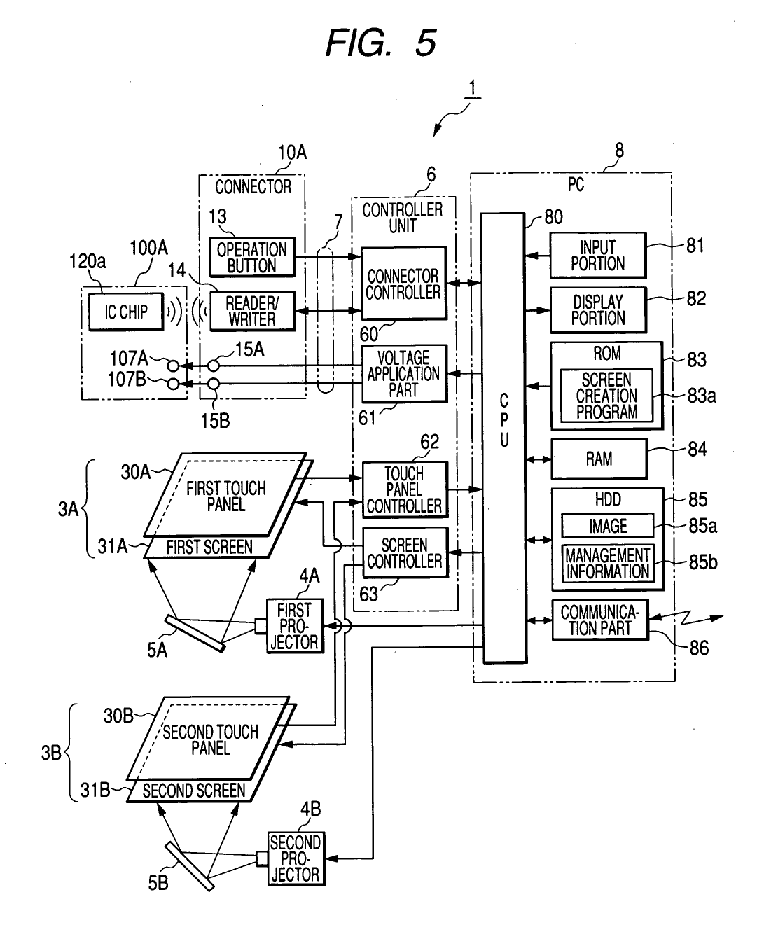

FIG. 5 is a block diagram showing a control system of the electronic paper system. In this electronic paper system, a controller unit 6 and the projectors 4A, 4B are connected to the PC 8, and the screen parts 3A, 3B and the connector 10A are connected to the controller unit 6. The operation button 13, the reader/writer 14 and the power feeding terminals 15A, 15B of the connector 10A are connected to the controller unit 6 through the cable 7 as described above.

(Configuration of Screen Part)

As shown in FIG. 5, the first screen part 3A is configured by laminating a first transparent touch panel 30A and a first screen 31A and is arranged so that the first touch panel 30A is located to the front side. In a manner similar to the first screen part 3A, the second screen part 3B is also configured by laminating a second transparent touch panel 30B and a second screen 31B and is arranged so that the second touch panel 30B is located to the front side.

In the first and second touch panels 30A, 30B, for example, a resistance film method (pressure sensitive method) is used, but an electromagnetic induction method, an electrostatic coupling method, an ultrasonic surface acoustic wave method, an infrared shielding method, etc. may be used.

The first and second screens 31A, 31B are in a light scattering state when a voltage is not applied, and shift to a light transmission state by application of a voltage, and a film (for example, Um Film manufactured by Nippon Sheet Glass Um Product Co., Ltd.) in which a nematic liquid crystal layer is dispersed into a polymer in drop shape and this is sandwiched between a pair of film substrates having a transparent electrode can be used.

(Configuration of Controller Unit)

The controller unit 6 includes a connector controller 60 for accepting a depression signal from the operation button 13 of the connector 10A and also sending and receiving management information between the reader/writer 14 and the connector controller, a voltage application part 61 for applying a pulse voltage to the power receiving terminals 107A, 107B of the electronic paper 100A through the power feeding terminals 15A, 15B, a touch panel controller 62 for inputting coordinate positions of the first and second touch panels 30A, 30B, and a screen controller 63 for switching the first and second screens 31A, 31B between a light scattering state and a light transmission state.

(Configuration of PC)

The PC 8 has a CPU 80 for controlling the whole electronic paper system and the inside of the PC 8, and an input part 81 such as a keyboard or a mouse, a display part 82 such as a liquid crystal display, ROM 83 for storing action programs such as a screen creation program 83a of the CPU 80, RAM 84 for temporarily storing data, an HDD 85 for storing an image 85a and management information 85b, etc. and a communication part 86 for communicating with a PC or a server of the outside on the Internet or a LAN (Local Area Network) are connected to this CPU 80.

(Action of Electronic Paper System)

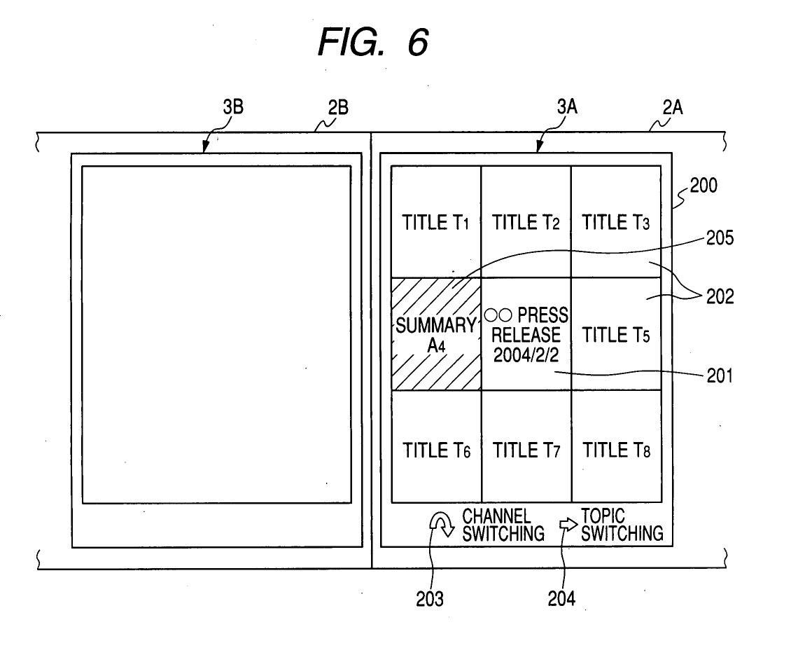

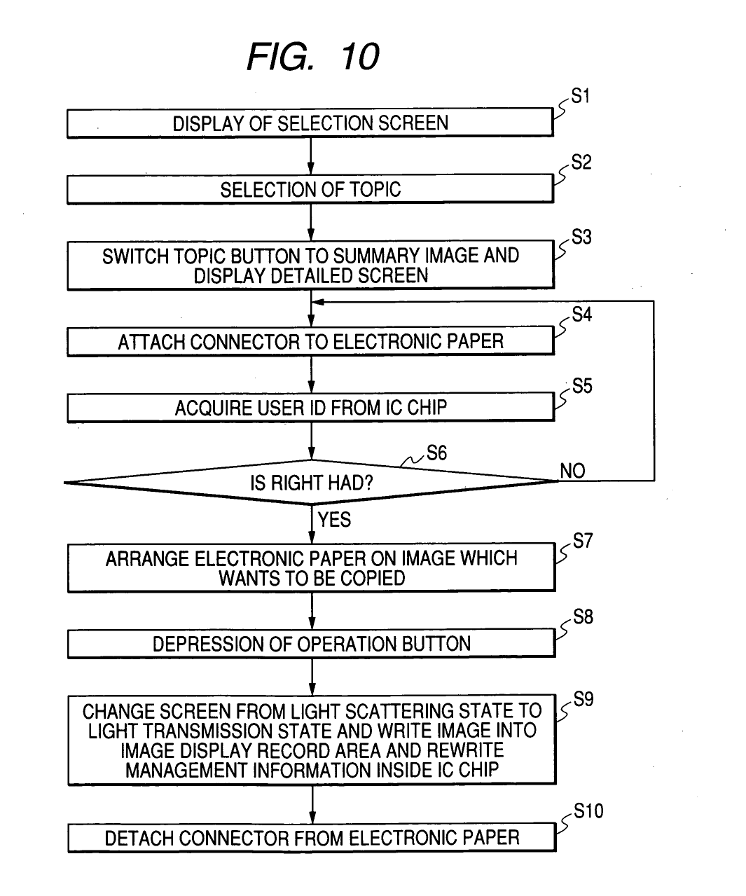

Next, an action of the electronic paper system will be described according to a flowchart of FIG. 10 with reference to FIGS. 6 to 9 showing a display example of the screen parts 3A, 3B.

When a power source of the image writing apparatus 1 is turned on, the CPU 80 of the PC 8 reads a selection screen out of the HDD 85 and sends its image signal to the first projector 4A. The first projector 4A projects image light of the selection screen on the first screen part 3A through the mirror 5A based on the image signal from the CPU 80 (S1).

FIG. 6 shows one example of the selection screen displayed on the first screen part 3A. On this selection screen 200, a channel display image 201 is displayed in the center as shown by “◯◯ press release” and in the periphery of the channel display image, eight topic buttons 202 having the size substantially equal to that of the image display record area 110 of the electronic paper 100A and displaying titles T1 to T8 are displayed in matrix shape and a channel switching key 203 and a topic switching key 204 are displayed in the lower side.

In this stage, a voltage is not applied to the first screen 31A of the first screen part 3A and the first screen 31A is in a light scattering state and the selection screen 200 projected on the first screen 31A can be viewed through the first touch panel 30A at a wide viewing angle. Also, the channel display image 201 and the topic buttons 202 are constructed so as not to be bright by blackening a background color and whitening a character color even when the whole surface of the first screen 31A is in a light transmission state.

The channel switching key 203 is means in which the contents of display switch from a channel displayed at present to another channel when this channel switching key is depressed by a finger, and the topic switching key 204 displays another topic button belonging to the channel displayed at present when this topic switching key is depressed by a finger.

It is assumed that a user touches one topic button 202 (for example, a hatched portion in FIG. 6) among the selection screen 200 and selects a title T4 (S2).

The touch panel controller 62 sends the coordinate information to the CPU 80. Based on the coordinate information sent from the touch panel controller 62, the CPU 80 reads a summary image 205 of a summary A4 corresponding to the title T4 and a detailed screen out of the HDD 85, and creates a screen in which the summary image 205 of the summary A4 is fitted instead of the topic button 202 of the title T4 on the RAM 84 based on the screen creation program 83a, and projects the image light 40 on the first screen 31A from the first projector 4A. Subsequently, the CPU 80 projects image light 40 of the detailed screen on the second screen part 3B from the second projector 4B (S3).

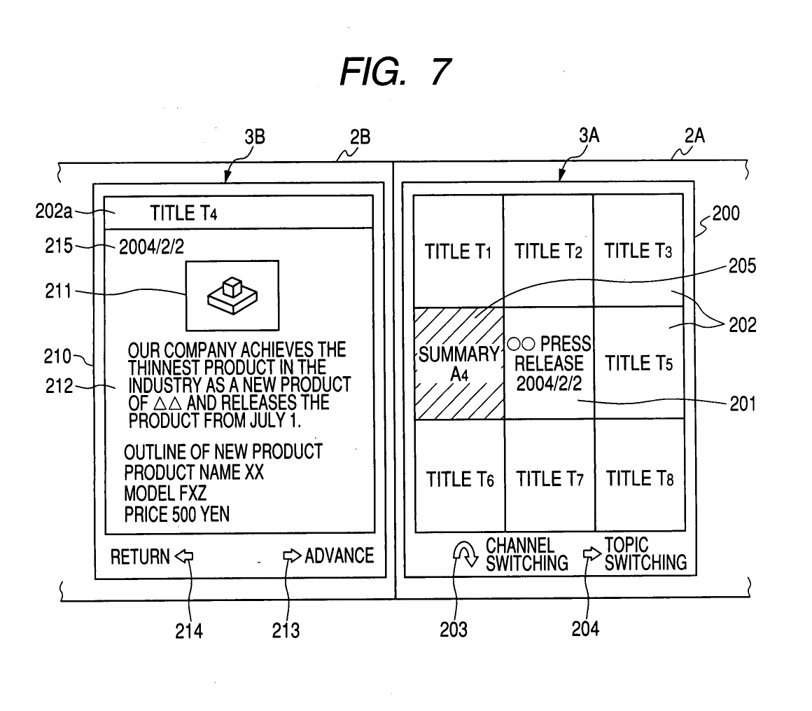

FIG. 7 shows one example of a detailed screen displayed on the second screen part 3B and a selection screen displayed on the first screen part 3A. Details of news are displayed in this detailed screen 210 using a topic image 202a of a title T4, an image 211, text 212, a date 215, etc. In a summary image 205 selected and displayed, a background color is whitened and a character color is blackened in a manner similar to normal paper. Here, when another topic button 202 is depressed, its topic button 202 switches to a corresponding summary image 205 and the second screen part 3B shifts to a detailed screen corresponding to it. At this time, the summary image 205 displayed until then may be returned to the topic button 202.

When a user copies an image among screens projected on the first and second screen parts 3A, 3B to the electronic paper 100A, the electronic paper 100A is attached to the attachment opening 12 of the connector 10A (S4) and the sides of a short side and a long side of the electronic paper 100A are respectively abutted on the abutment surfaces 12a, 12b of the attachment opening 12 as shown in FIG. 1 and FIG. 4A. When the electronic paper 100A is arranged in a predetermined abutment position, the limit switch 19 is turned on and the LED lamp 13a buried in the operation button 13 illuminates green. In this state, the power feeding terminals 15A, 15B of the connector 10A are in contact with the power receiving terminals 107A, 107B of the electronic paper 100A.

The reader/writer 14 of the connector 10A performs continuous reading actions for detecting a unique ID of the IC chip 120a adjacent always by a control signal from the connector controller 60 based on control of the CPU 80. By inserting the electronic paper 100A into the connector 10A, the unique ID (can also be called a user ID of an owner) of the IC chip 120a inside the electronic paper 100A is read as a part of management information (S5) and the acquired unique ID (user ID) is sent to the CPU 80 through the connector controller 60. The CPU 80 retrieves the management information 85b stored in the HDD 85 using the user ID as a retrieval key, and decides whether or not the user is a person having the right to obtain contents information (S6). In the case that the user does not have the right, even when the operation button 13 of the connector 10A is depressed, no change occurs and the flowchart does not proceed to processing subsequent to step S9. In this case, it waits for timing for reading the unique ID (user ID) of the IC chip in which use of the contents information is permitted again (S4).

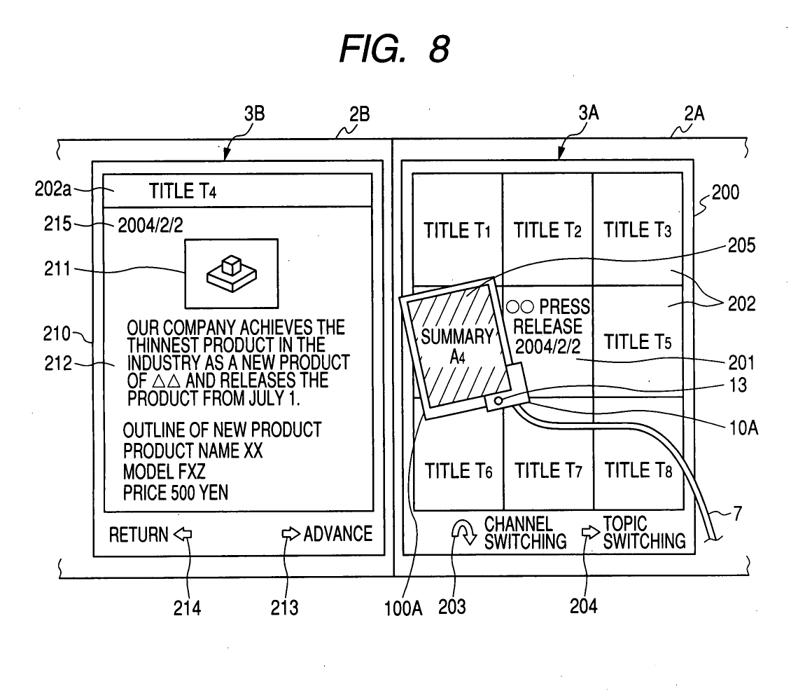

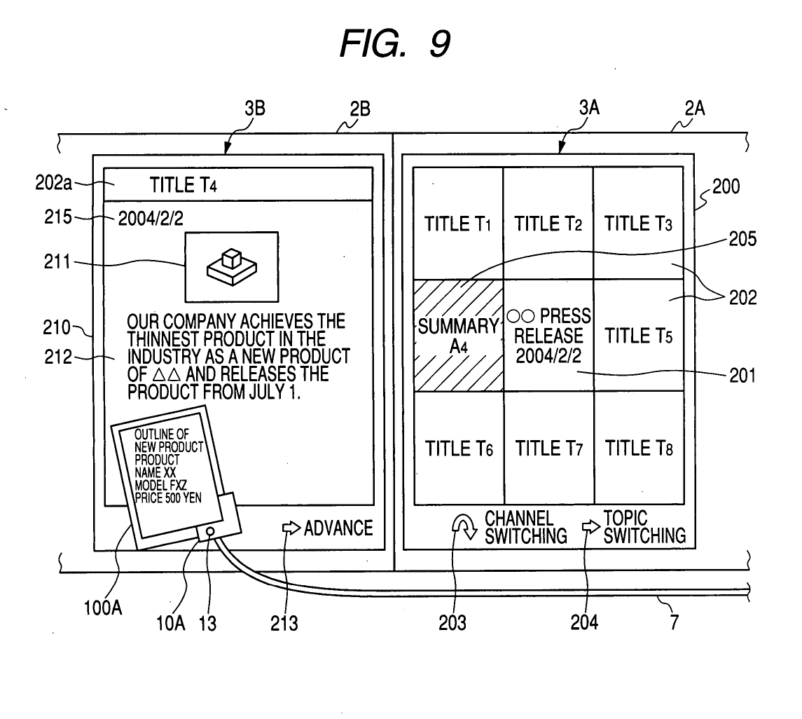

In the case that the user has the right in step S6, the electronic paper 100A is arranged on an image which wants to be copied. For example, the electronic paper 100A attached to the connector 10A is brought close to a place which wants to be copied among images displayed on the screen part 3 and is arranged as shown in FIG. 8 when the summary image 205 wants to be copied or as shown in FIG. 9 when a part of the detailed screen 210 wants to be copied (S7).

Next, the user depresses the operation button 13 of the connector 10A (S8). Its depression signal is sent to the CPU 80 of the PC 8 through the cable 7 and the controller unit 6. The screen controller 63 switches the first and second screens 31A, 31B from a light scattering state to a light transmission state (S9).

Subsequent to this, the CPU 80 applies a pulse voltage to the power receiving terminals 107A, 107B of the electronic paper 100A through the power feeding terminals 15A, 15B of the connector 10A by the voltage application part 61. As a result of this, an image is written into the image display record area 110 of the electronic paper 100A as described above. In parallel with this, the CPU 80 sends updating information for updating accounting information recorded into the IC chip 120a and source information (for example, a URL (Uniform Resource Locator)) about an image written into the electronic paper 100A to the reader/writer 14. The reader/writer 14 updates the accounting information inside the IC chip 120a and also writes the URL into the IC chip 120a (S9).

When rewriting of the image and rewriting of the management information are completed, the user detaches the electronic paper 100A from the connector 10A (S10). The image written into the electronic paper 100A continues to be displayed over the long term even without a power source, and the management information written into the IC chip 120a is provided for management of the user, the electronic paper 100A, the image, etc.

Incidentally, particularly when it is unnecessary to impose limitations on a user using contents, there can naturally be the case of proceeding to actions subsequent to S9 at the time of depressing the operation button 13 without reading the unique ID (or a user ID of an owner) on the electronic paper 100A inserted into the connector 10A among the flowchart described above and collating the unique ID with a list of the inside of the PC 8.

### Effect of First Embodiment

The following effects can be obtained according to this first embodiment.

(A) Rewriting of an image and rewriting of management information are performed by one operation of the operation button 13, so that the operation becomes simple and easy.

(B) A URL of an image written into the electronic paper 100A is written into the IC chip 120a, so that the URL recorded into the IC chip 120a can be read out to invoke a corresponding image on a screen again by holding the electronic paper 100A to which an image is copied over a reader/writer for URL reading even when screen information projected on the first screen part 3A or the second screen part 3B changes to another contents or is deleted due to a lapse of time, etc. As a result of this, even for transient information temporarily displayed on the screen, utilization and sharing of information can be promoted at intervals by using the electronic paper.

(C) Since the projector 4 with a deep focal depth is used as a display, it is unnecessary to bring the electronic paper 100A into intimate contact with a screen, so that dirt or a flaw of the electronic paper 100A can be reduced and an electronic paper system with ease of use can be provided.

(D) Management information is read and written with respect to the electronic paper 100A by noncontact, so that there is no problem of wear etc. in a connection terminal and long life can be achieved.

(E) Management information is read and written from a place close to an RFID tag, so that power in a signal of sending and receiving is not required too much and also a situation in which noise breaks into the signal reduces and reliability of reading and writing of the management information improves.

### Second Embodiment

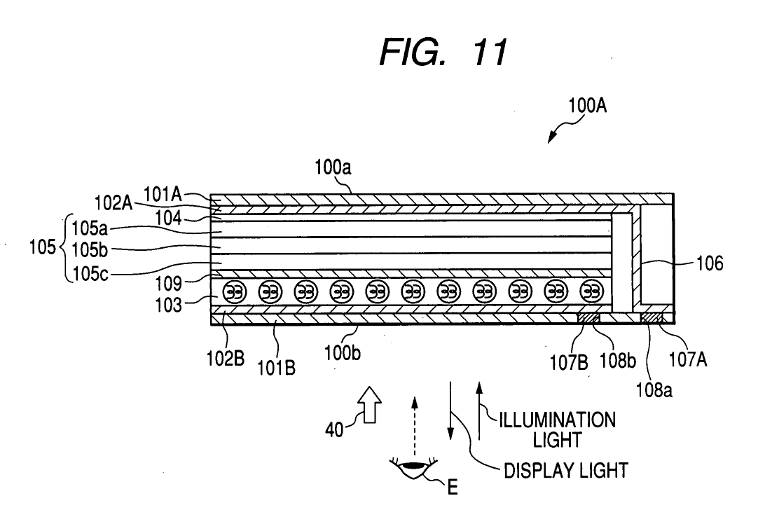

FIG. 11 shows electronic paper according to a second embodiment of the invention. Electronic paper 100A shown in FIG. 11 is means of a light writing type and in the configuration of FIG. 3, it is configured so that arrangement of a liquid crystal layer 103 and a photoconductive layer 105 is replaced and also an isolation layer 109 is provided between the liquid crystal layer 103 and a light absorption layer 104 and further the light absorption layer 104 is disposed inside a transparent electrode 102A. According to this, an image is written on a principle similar to that of the electronic paper 100A described above and the photoconductive layer 105 is irradiated with image light 40 through a substrate 101B, the liquid crystal layer 103 and the isolation layer 109 and a viewing direction becomes equal to a direction of irradiation with the image light 40. Therefore, it is unnecessary to transmit light to the front 100a, so that display information in arrangement in which the electronic paper 100A is attached to a wall etc. can be rewritten and use can be made as a display surface of advertisement or design.

### Third Embodiment

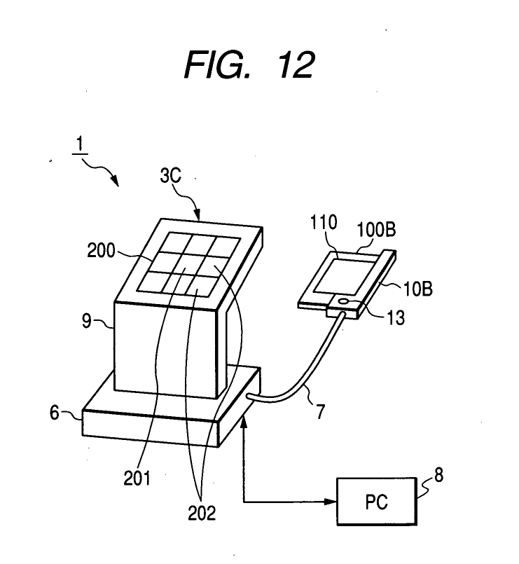

FIG. 12 is a perspective view showing an electronic paper system according to a third embodiment of the invention. This electronic paper system is configured to have self-writing type electronic paper 100B acting as a display record medium and an image writing apparatus 1 for writing image information and management information about the image information into this electronic paper 100B.

The image writing apparatus 1 is configured to have a stand 9 having a screen part 3C, a controller unit 6 arranged in a lower portion of the stand 9, a connector 10B for supplying a power source to the self-writing type electronic paper 100B through a cable 7 and a PC 8 connected to the controller unit 6.

The self-writing type electronic paper 100B is constructed so that an image display record area 110 is configured by sandwiching a display material having memory properties by plural X electrodes and plural Y electrodes and passive matrix driving is performed by an X driver and a Y driver described below, and an RFID tag is provided in a record area of management information in a manner similar to the first embodiment. Incidentally, the self-writing type electronic paper 100B may be constructed so that the image display record area 110 is configured by sandwiching a display material having memory properties by a total electrode and plural pixel electrodes and active driving is performed using a TFT driving element etc. or driving is performed by a segment electrode divided into plural display areas.

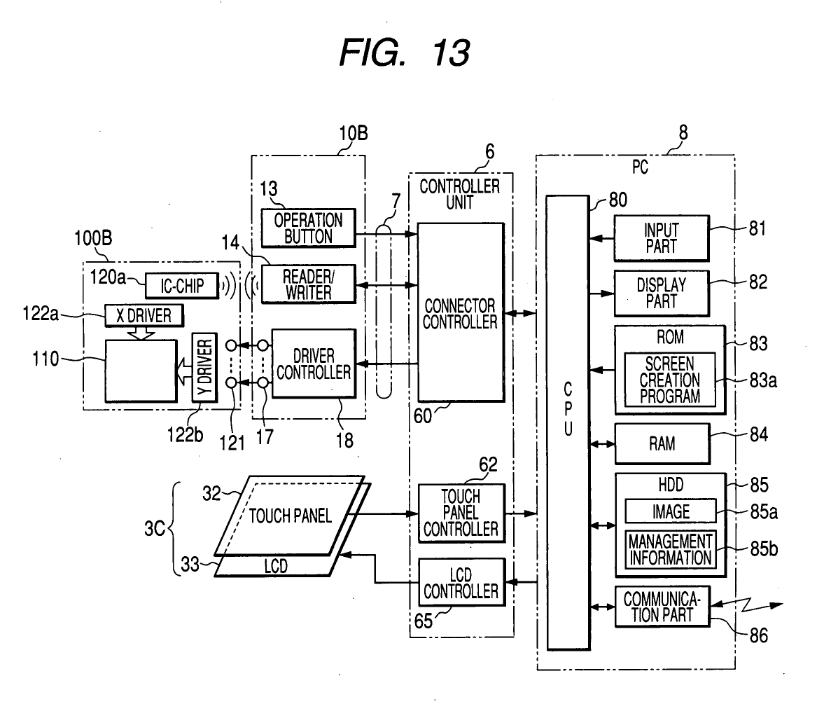

FIG. 13 is a block diagram showing a control system of the electronic paper system according to this third embodiment. In this electronic paper system, the controller unit 6 is connected to the PC 8, and the screen part 3C and the connector 10B are connected to the controller unit 6.

(Configuration of Connector)

The connector 10B is means in which a driver controller 18 is added and an output terminal corresponding to an input terminal of the electronic paper 100B is provided with respect to the connector 10A of the first embodiment, and the other is configured in a manner similar to the first embodiment. The driver controller 18 is means for generating a data signal, a control signal, a driving voltage, etc. supplied to an X driver 122a and a Y driver 122b of the electronic paper 100B. Incidentally, the driver controller 18 may be provided in the controller unit 6 in order to miniaturize the connector 10B.

(Configuration of Screen Part)

The screen part 3C is configured by laminating a transparent touch panel 32 and an LCD 33 and is arranged so that the touch panel 32 is located to the front side. In a manner similar to the first embodiment, a resistance film method (pressure sensitive method) is used in the touch panel 32, but an electromagnetic induction method, an electrostatic coupling method, an ultrasonic surface acoustic wave method, an infrared shielding method, etc. may be used. Also, a simple matrix type LCD is used in the LCD 33 and a touch panel function may be provided in this LCD to detect coordinates by an electrostatic coupling method. As a result of this, there is no need to provide a touch panel separately, so that the screen part can be thinned.

(Configuration of Controller Unit)

The controller unit 6 of this third embodiment includes a connector controller 60 for accepting a depression signal from an operation button 13 of the connector 10B and also sending and receiving management information between a reader/writer 14 and the connector controller and outputting a necessary control signal to the driver controller 18, a touch panel controller 62 for inputting a coordinate position of the touch panel 32, and an LCD controller 65 for performing display control of the LCD 33.

(Action of Electronic Paper System)

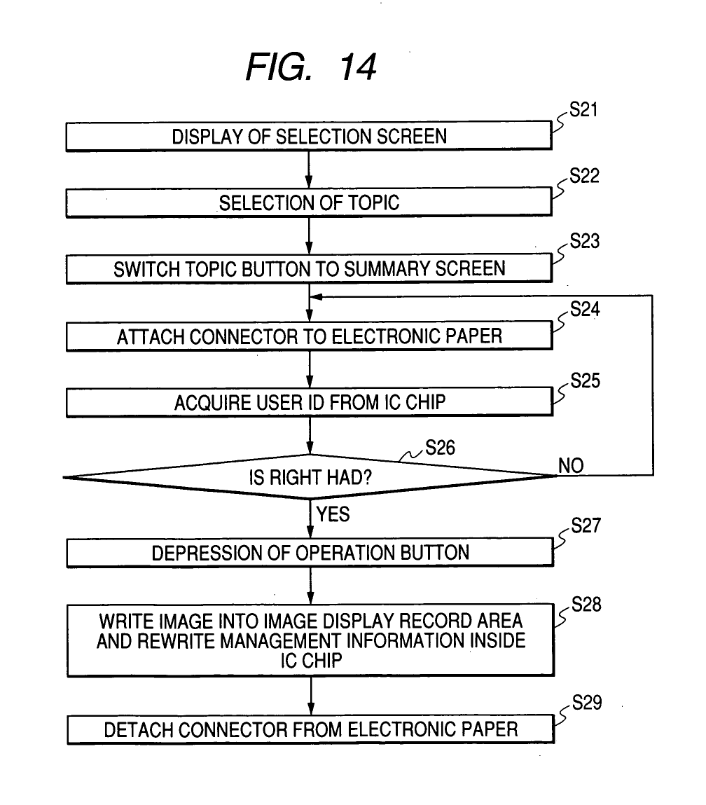

Next, an action of the electronic paper system will be described according to a flowchart of FIG. 14. When a power source is turned on, a selection screen similar to that of the first embodiment is displayed on the screen part 3C by control of the PC 8 (S21). That is, on this selection screen 200, a channel display image 201 is displayed in the center and in the periphery of the channel display image, eight topic buttons 202 having the size substantially equal to that of the image display record area 110 of the electronic paper 100B and displaying titles are displayed in matrix shape and a channel switching key and a topic switching key are displayed in the lower side.

When a user touches one topic button 202 among the selection screen 200 and selects a title (S22), the touch panel controller 62 sends the coordinate information to a CPU 80. Based on the coordinate information sent from the touch panel controller 62, the CPU 80 reads a summary image corresponding to the selected title and a detailed screen out of an HDD 85, and creates a screen in which the summary image is fitted instead of the topic button 202 on RAM 84 based on a screen creation program 83a, and displays its image on the LCD 33 by the LCD controller 65 (S23).

When the user wants to copy the summary image displayed on the screen part 3C to the electronic paper 100B, the electronic paper 100B is attached to an attachment opening of the connector 10B (S24). In this state, an output terminal 17 of the connector 10B is in contact with an input terminal 121 of the electronic paper 100B.

The reader/writer 14 of the connector 10B acquires management information including a user ID from an IC chip 120a of the electronic paper 100B (S25) and sends the management information to the CPU 80. The CPU 80 retrieves management information 85b stored in the HDD 85 using the user ID as a retrieval key, and decides whether or not the user is a person having the right to obtain contents information (S26). In the case that the user does not have the right, even when subsequent depression of the operation button 13 is executed (S27), the flowchart again returns to S24 without performing processing subsequent to step S28 and it waits for the user having the contents information to insert the electronic paper 100B into the connector 10B.

In the case that the user has the right to obtain the contents information in step S26, by depression of the operation button 13 of the connector 10B (S25), its depression signal is sent to the CPU 80 of the PC 8 through the cable 7 and the controller unit 6.

Thereafter, the driver controller 18 supplies a data signal, a control signal and a driving voltage, etc. to the X driver 122a and the Y driver 122b through the output terminal 17 and the input terminal 121 under control of the CPU 80. The X driver 122a and the Y driver 122b write an image into the image display record area 110 by performing passive driving of an X electrode and a Y electrode. In parallel with this, the CPU 80 sends updating information for updating accounting information recorded into the IC chip 120a and source information (for example, a URL) about an image written into the electronic paper 100B to the reader/writer 14. The reader/writer 14 updates the accounting information inside the IC chip 120a and also writes the URL into the IC chip 120a (S28).

When rewriting of the image and rewriting of the management information are completed, the user detaches the electronic paper 100B from the connector 10B (S29). The image written into the electronic paper 100B continues to be displayed over the long term even without a power source, and the management information written into the IC chip 120a is provided for management of the user, the electronic paper 100B, the image, etc.

Incidentally, particularly when it is unnecessary to impose limitations on a user using contents, there can naturally be the case of proceeding to actions subsequent to S28 at the time of depressing the operation button 13 without reading a unique ID (or a user ID of an owner) on the electronic paper 100B inserted into the connector 10B among the flowchart described above and collating the unique ID with a list of the inside of the PC 8.

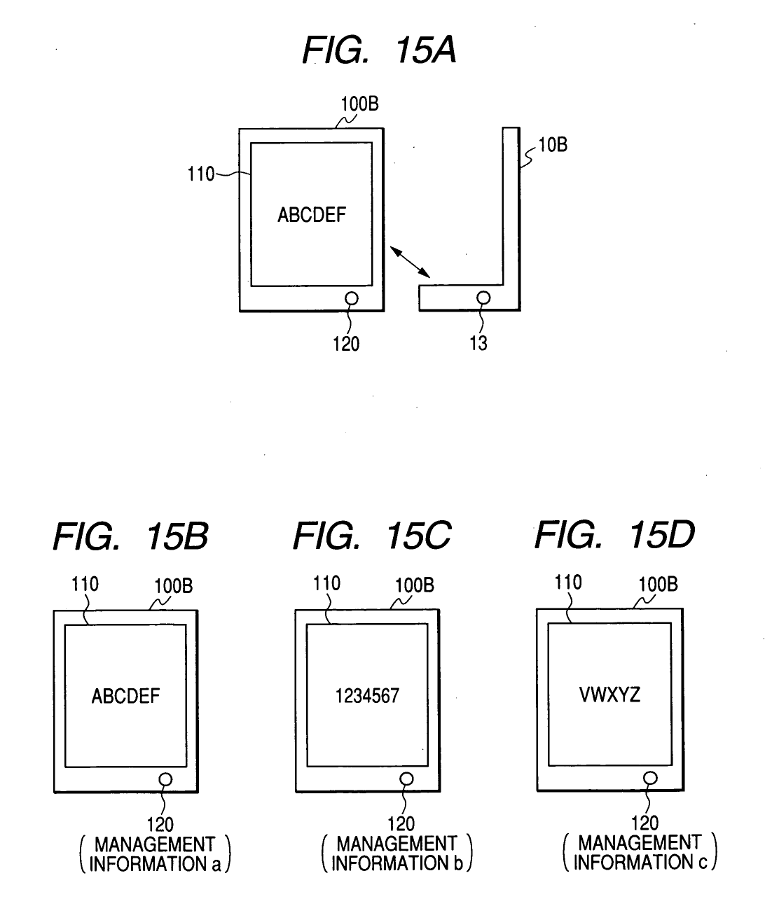

FIG. 15 is a view showing use forms of the electronic paper system according to the third embodiment. The connector 10B can be attached to and detached from the electronic paper 100B as shown in FIG. 15A, so that as shown in FIGS. 15B to 15D, an image may be written into the image display record area of the electronic paper 100B to record management information a to c different corresponding to this into the IC chip.

### Effect of Third Embodiment

The following effects can be obtained according to this third embodiment.

(A) Rewriting of an image and rewriting of management information are performed by one operation of the operation button 13, so that the operation becomes simple and easy in a manner similar to the first embodiment.

(B) A URL of an image written into the electronic paper 100B is written into an IC chip, so that the corresponding image can be acquired by reading out the URL recorded into the IC chip by a reader/writer even when an image on the electronic paper 100B is deleted.

Next, a connector according to a fourth embodiment of the invention will be described. This fourth embodiment is provided with a communication part for receiving an image and management information from the outside by wire or wireless independently of a PC, memory in which the received image information and management information are stored, a controller in which an image writing signal is outputted to the output terminal 17 and the input terminal 121 based on the image information stored in the memory by depression of the operation button 13 and an IC chip of the electronic paper 100B is rewritten by the reader/writer 14 based on the management information stored in the memory and a battery for supplying electric power to each the part of the connector and the X driver and the Y driver of the electronic paper 100B in the third embodiment. By providing a function equivalent to that of the image writing apparatus for the connector thus, the system can be miniaturized.

### Other Embodiment

Incidentally, the invention is not limited to each the embodiment described above and various modifications can be made without departing from the subject matter. For example, components between each of the embodiments can be combined arbitrarily.

Also, by writing various information as management information, it can be applied to various systems without being limited to the system described above.

Also, in the embodiment described above, an image writing signal from the connector to the display record medium is sent by bringing a terminal of the connector side into contact with a terminal of the medium side, but the signal may be sent by noncontact by making connection optically, magnetically or thermally.

Also, in addition to the display record medium described above, a heat-sensitive record medium using leuco dye, a liquid crystal having memory properties typified by a ferroelectric liquid crystal, other display record media of an electrophoretic method for switching display by moving charged particles in liquid, a toner display method for switching display by moving charged particles in air, a particle rotation method for switching display by rotating charged particles, a magnetic migration method for switching display by moving particles by magnetism, etc. may be used as a display record medium having memory properties.

Also, in the first embodiment, the projector is used as a display device, but instead of the projector, by a projector in which a display device such as a CRT display or a plasma display is combined with an image formation optical system, image light from the display device may be formed in the image display record area of the electronic paper.

Also, instead of the projector, a CRT display or a flat display such as an LCD (liquid crystal display), an ELD (electroluminescent display), a PDP (plasma display), a VFD (vacuum fluorescent display), an LED (light emitting diode) display, an FED (field emission display) may be used as a display device to bring the electronic paper into intimate contact with an image display surface.

Also, management information may be written into a display record medium by the same means as means for writing an image. For example, it is contemplated to write the management information into the image display record area 110. As a result of this, the need for a device (such as a reader/writer) dedicated to reading and writing of the management information is eliminated and a configuration can be simplified.

Also, a memory card into which management information is written is provided detachably in the electronic paper and the memory card into which the management information is written may be inserted into a slot of an external device of a PC etc. to read the management information out of the memory card. As a result of this, usability of the management information increases.

In addition, an IC card of a non-contact type detachably provided in the electronic paper may be used instead of providing an IC chip in the electronic paper as described in the above embodiments.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. An image writing apparatus comprising:
a connector capable of being attached to and detached from a display record medium capable of rewriting information and visibly displaying image information without a power source,
a button which is provided on the connector and outputs a writing command signal of the information by an operation, and
a writing part which applies a writing signal of the image information and management information about the image information from the connector to the display record medium by control of a control part based on the writing command signal.

2. The image writing apparatus according to claim 1, wherein
the display record medium includes: a first area into which the image information is written; and a second area into which the management information is written, and
the writing part includes: a first writing part for writing the image information into the first area; and a second writing part for writing the management information into the second area.

3. The image writing apparatus according to claim 2, wherein the second writing part reads the management information out of the second area and rewrites the original management information into new management information according to its read result.

4. The image writing apparatus according to claim 2, wherein the control part determines whether or not the image information can be written based on the management information read by the second writing part.

5. The image writing apparatus according to claim 2, wherein
the first area of the display record medium has a configuration in which a liquid crystal layer and a photoconductive layer are laminated and the layers are sandwiched between a pair of electrodes, and
the first writing part is a light writing part for applying a voltage between a pair of the electrodes through the connector and also irradiating the first area with image light to write the image information.

6. The image writing apparatus according to claim 5, wherein
the light writing part includes: a screen made of a light control layer capable of changing between a light scattering state and a light transmission state; and a projector for projecting the image light on the screen, and
based on the writing command signal, the control part changes the screen to the light transmission state and irradiates the first area with the image light through the screen to write the image information.

7. The image writing apparatus according to claim 5, wherein in the first area of the display record medium, the image light is written into a first surface and the image is displayed on a second surface opposite to the first surface.

8. The image writing apparatus according to claim 2, wherein the second writing part is provided in the connector and reads and writes the management information with respect to the second area.

9. The image writing apparatus according to claim 8, wherein the second writing part reads and writes the management information by noncontact.

10. The image writing apparatus according to claim 2, wherein the second writing part writes information indicating a source of the image information written into the first area into the second area as the management information.

11. A connector capable of being attached to and detached from a display record medium having rewritable image display area and management information record area, comprising:
a button which output a writing command signal to the image display area and the management information record area by an operation;
an output terminal which applies a writing signal of image information to the image display area by making connection to an input terminal of the display record medium when the connector is attached to the display record medium; and
a reading and writing part which reads and writes management information about the image information with respect to the management information record area.

12. The connector according to claim 11, wherein the image information and the management information are respectively written into the image display area and the management information record area after the information is received from the outside and is stored in memory provided in the inside.

13. A display record medium having rewritable image display area and management information record area, comprising:
a memory card detachably provided on the display record medium,
wherein the management information record area is formed in the memory card.
